(19) United States
(12) Patent Application Publication
(10) Pub. No.: US 2007/0017194 A1
(43) Pub. Date: Jan. 25, 2007

(54) Air duct outlets having porous material coverings

(76) Inventors: Thomas Franz Josef Gehring, Scarborough (CA); Ireneusz Jankowski, Richmond Hill (CA); Dejan Havidic, Toronto (CA)

Correspondence Address: MYERS BIGEL SIBLEY & SAJOVEC, PO BOX 37428, RALEIGH, NC, 27627, US

(21) Appl. No.: 11/188,283

(22) Filed: Jul. 25, 2005

(51) Int. Cl. B01D 46/00

(52) U.S. Cl. 55/505

(57) ABSTRACT

An air duct outlet includes a housing that defines an air passageway with an inlet and outlet, and a porous layer of material that overlies the air passageway outlet and hides the air duct outlet from view. The porous layer of material is configured to soften and diffuse an air stream flowing through the air passageway outlet and/or to cause an air stream flowing through the air passageway outlet to be directed in one or more directions.

### RELATED APPLICATION

This application claims the benefit of and priority to U. S. Provisional Patent Application No. 60/590,240, filed Jul. 22, 2004, the disclosure of which is incorporated herein by reference as if set forth in its entirety.

### FIELD OF THE INVENTION

The present invention relates generally to air distribution systems and, more particularly, to air duct outlets utilized within air distribution systems.

### BACKGROUND OF THE INVENTION

Conventionally, vehicle interiors are provided with one or more air duct outlets which are connected by ducts to an outside air source and/or to a heating and/or air conditioning system that provides cooled and/or heated (“conditioned”) air. Because it is generally desirable for vehicle occupants to be able to adjust the direction of air flow within a vehicle interior, air duct outlets are typically provided with adjustable vanes or louvers. In addition, air duct outlets may be provided with dampers that allow vehicle occupants to control the amount of air flowing therethrough. Similarly, air distribution systems for residential and commercial buildings utilize air duct outlets to direct and control the amount of air flow.

Conventional air duct outlets in both vehicles and buildings typically utilize one or more sets of louvers to mechanically redirect an air stream flowing therethrough. While this technology is proven and successful, louver assemblies can be complex and expensive to manufacture. In addition, conventional air duct outlets in vehicle air distribution systems typically provide an air stream deflection range up to only about 90° (i.e., −45° to +45° relative to a centerline of the flow direction of an air stream). Air stream deflection ranges in excess of ±45° in conventional air duct outlets typically result in large pressure drops and lower air flow rates, which can be undesirable.

In addition, air duct outlets are conventionally designed to allow the passage of a large amount of air so that the cabin of a vehicle can be cooled/heated as rapidly as possible. However, passengers typically can tolerate relatively high airflow rates only for a limited time before starting to feel uncomfortable. This problem has been addressed by the use of oscillating air duct outlets wherein a pivoting set of louvers causes an air stream flowing therethrough to oscillate or sweep back and forth such that a passenger experiences direct airflow only for limited durations. For example, the Mazda 626 automobile incorporates an oscillating air duct outlet. This air duct outlet uses a small direct current (DC) motor (geared down to low rotational speed) to drive a crank which, through a shaft, mechanically moves air-directing louvers back and forth in an oscillating pattern, thereby imparting a sweeping motion to an air stream.

Unfortunately, the use of motors and associated rotational linkages to generate oscillating air stream motion can be somewhat complicated and expensive. Vehicle manufacturers are continuously seeking components, such as air duct outlets, that have enhanced functionality and durability, yet are cost effective to manufacture. Vehicle manufacturers are also continuously seeking components, such as air duct outlets, that can enhance styling within a vehicle, yet remain functional and economical.

### SUMMARY OF THE INVENTION

In view of the above discussion, an air duct outlet includes a housing that defines an air passageway with an inlet and outlet, and a porous layer of material (e.g., woven, nonwoven, combination woven and nonwoven) that overlies the air passageway outlet and hides the air duct outlet from view. The porous layer of material is configured to soften and diffuse an air stream flowing through the air passageway outlet. According to embodiments of the present invention, the porous layer of material is configured to cause an air stream flowing through the air passageway outlet to be directed in one or more directions. According to embodiments of the present invention, the porous layer of material is configured to cause an air stream flowing through the air passageway outlet to generate a predetermined audible tone, for example, a pleasing, soothing audible tone. According to embodiments of the present invention, the porous layer of material may be formed from virtually any type of material including, but not limited to, woven fabrics, nonwoven fabrics, and combinations of woven and nonwoven fabrics.

According to another embodiment of the present invention, a vehicle instrument panel includes a plurality of perforated portions that are in communication with an air source. An air stream flowing from an air source flows through the one or more perforated portions and into the passenger compartment of the vehicle. A porous layer of material overlies the instrument panel and hides the perforated portions from view. The porous layer of material also softens and diffuses air flowing through the one or more perforated portions from the air source. According to embodiments of the present invention, the porous layer of material causes an air stream flowing through the perforated portions of the instrument panel to spread out in one or more directions.

### BRIEF DESCRIPTION OF THE DRAWINGS

The accompanying drawings, which form a part of the specification, illustrate embodiments of the present invention. The drawings and description together serve to fully explain the invention.

FIG. 1 is a front, perspective view of an air duct outlet mounted within an instrument panel of a vehicle, according to embodiments of the present invention.

FIG. 2 is a front, perspective view of an air duct outlet mounted within an instrument panel of a vehicle, according to other embodiments of the present invention.

FIG. 3 is a perspective view of a vehicle instrument panel according to embodiments of the present invention.

FIGS. 4A-4B are enlarged cross-sectional views of a woven material configured to direct the flow of air therethrough, according to embodiments of the present invention.

FIGS. 5-6 illustrate the use of the woven material of FIGS. 4A-4B to direct the flow of air from air duct outlets positioned in generally horizontal orientations, according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

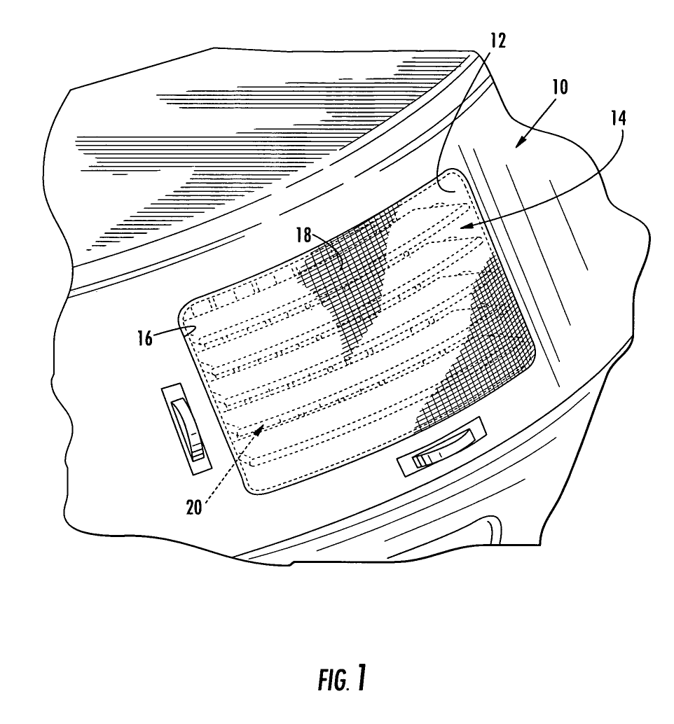

Referring to FIG. 1, an air duct outlet 10, according to embodiments of the present invention, includes a housing 12 that defines an air passageway 14 with an inlet (not shown) and outlet 16. A porous layer of material 18 overlies the air passageway outlet 16 and hides the air duct outlet 10 from view. The porous layer of material 18 softens and diffuses an air stream flowing through the air passageway outlet 16.

In the illustrated embodiment of FIG. 1, the air duct outlet 10 includes a louver assembly 20 within the housing 12 that allows a user to adjust the direction of air flowing out of the air duct outlet 10. This louver assembly 20 is substantially hidden from view by the porous layer of material 18. However, how much of the air duct outlet 10 (and any internal components, such as louver assembly 20) is hidden from view is a matter of aesthetics. The porous layer of material 18 may be configured to completely hide, or only partially hide the air duct outlet 10 and any internal components, such as louver assembly 20. As used herein with respect to a porous layer of material, the terms “hide” and “hidden” shall mean completely hidden, substantially hidden and partially hidden.

The terms “soften and diffuse” as used herein refers to modifying airflow from an air duct outlet so a person does not feel a direct and uncomfortable flow of air. Embodiments of the present invention allow the same amount of airflow as conventional air duct outlets but without the harsh, direct feel of conventional air duct outlets. According to embodiments of the present invention, a person may not even be able to tell where air flow is coming from.

The porous layer of material 18 may be configured (e.g., via the weave pattern if a woven material) to deliver a predetermined flow rate of air. According to embodiments of the present invention, the porous layer of material 18 may be configured to cause an air stream flowing therethrough to generate a predetermined (e.g., pleasing, soothing, etc.) audible tone.

According to embodiments of the present invention, the porous layer of material 18 may be formed from virtually any type of material including, but not limited to, woven fabrics, nonwoven fabrics, and combinations of woven and nonwoven fabrics. According to embodiments of the present invention, the porous layer of material 18 may include a metallic mesh. Moreover, the porous layer of material 18 may include a combination of metallic mesh and fabric (e.g., woven fabric, nonwoven fabric, combinations of woven and nonwoven fabric, etc.). The fabric can be chosen to optimize desired properties, such as airflow direction, softness of air flow, how much an air flow is diffused, audible tone generated by airflow, etc.

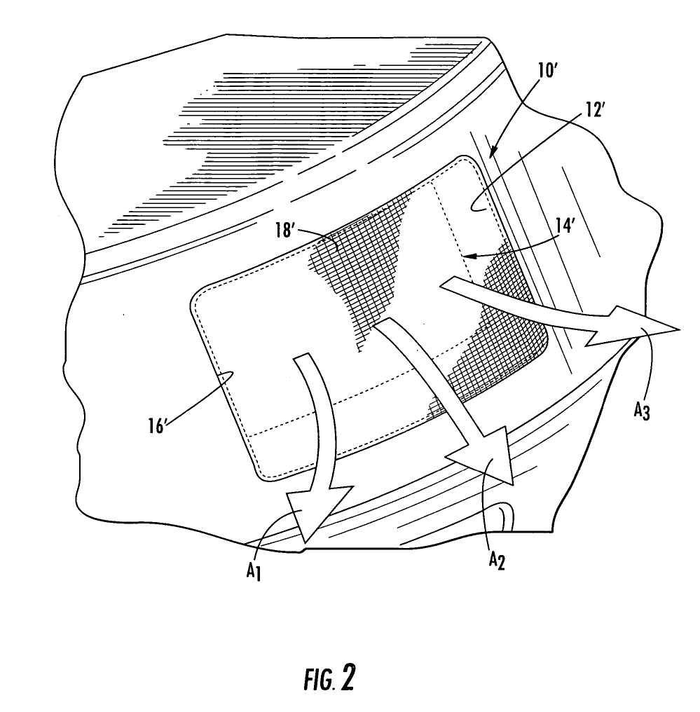

Referring to FIG. 2, an air duct outlet 10′, according to another embodiment of the present invention and that is similar in structure to the air duct outlet 10 of FIG. 1, but without a louver assembly for directing air flow, is illustrated. The air duct outlet 10′ includes a housing 12′ that defines an air passageway 14′ with an inlet (not shown) and outlet 16′. A porous layer of material 18′ overlies the air passageway outlet 16′ and hides the air duct outlet 10′ from view. The porous layer of material 18′ softens and diffuses an air stream flowing through the air passageway outlet 16′. In addition, the porous layer of material 18′ causes an air stream flowing through the air passageway outlet 16′ to spread out in one or more directions. In the illustrated embodiment, the porous layer of material 18′ causes an air stream to spread out in multiple directions as indicated by arrows A₁, A₂, A₃. The porous layer of material 18′ may be configured to direct an air stream in a single direction or any number of different directions, as desired.

The porous layer of material 18′ may be configured (e.g., via the weave pattern if a woven material) to deliver a predetermined flow rate of air. According to embodiments of the present invention, the porous layer of material 18′ may be configured to cause an air stream flowing therethrough to generate a predetermined (e.g., pleasing, soothing, etc.) audible tone.

According to embodiments of the present invention, the porous layer of material 18′ may be formed from virtually any type of material including, but not limited to, woven fabrics, nonwoven fabrics, and combinations of woven and nonwoven fabrics. According to embodiments of the present invention, the porous layer of material 18′ may include a metallic mesh. Moreover, the porous layer of material 18′ may include a combination of metallic mesh and fabric (e.g., woven fabric, nonwoven fabric, combinations of woven and nonwoven fabric, etc.).

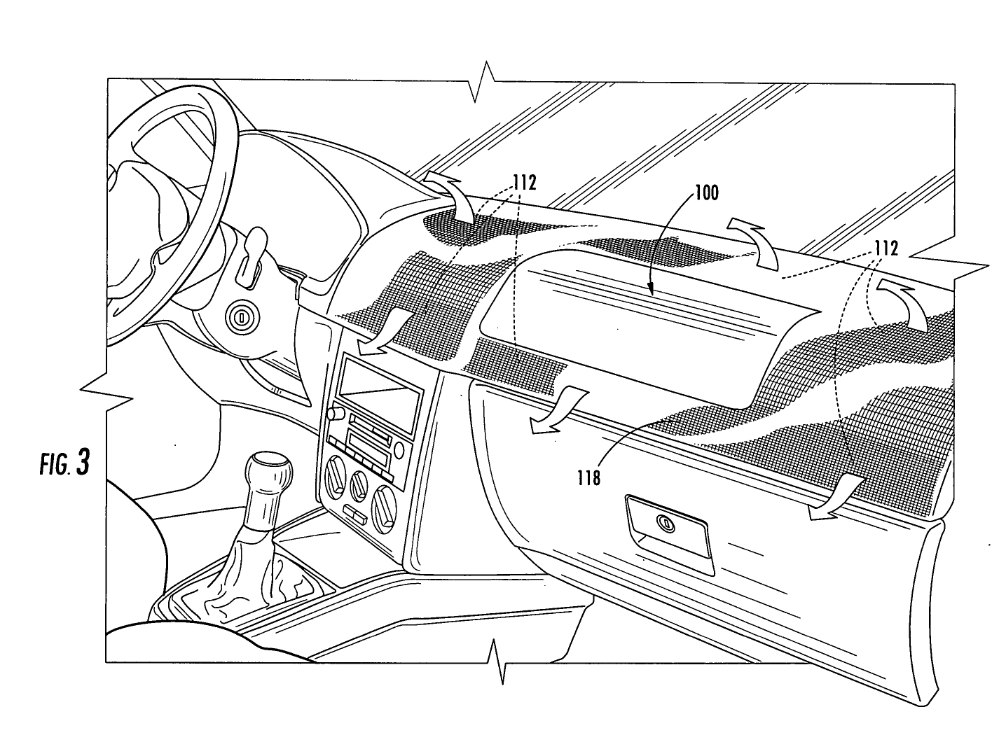

According to another embodiment of the present invention illustrated in FIG. 3, a vehicle instrument panel 100 includes a plurality of perforated portions 112 that are in communication with an air source, for example, via one or more ducts (not shown). An air stream flowing from an air source flows through the one or more perforated portions 112 and into the passenger compartment of the vehicle. A porous layer of material 118 overlies the instrument panel 100 and hides the perforated portions 112 from view. The porous layer of material 118 also softens and diffuses air flowing through the one or more perforated portions from the air source. According to embodiments of the present invention, the porous layer of material 118 causes an air stream flowing through the perforated portions of the instrument panel 100 to spread out in one or more directions. In the illustrated embodiment, the porous layer of material 118 causes an air stream to spread out in multiple different directions.

The porous layer of material 118 may be configured (e.g., via the weave pattern if a woven material) to deliver a predetermined flow rate of air. According to embodiments of the present invention, the porous layer of material 118 may be configured to cause an air stream flowing therethrough to generate a predetermined (e.g., pleasing, soothing, etc.) audible tone.

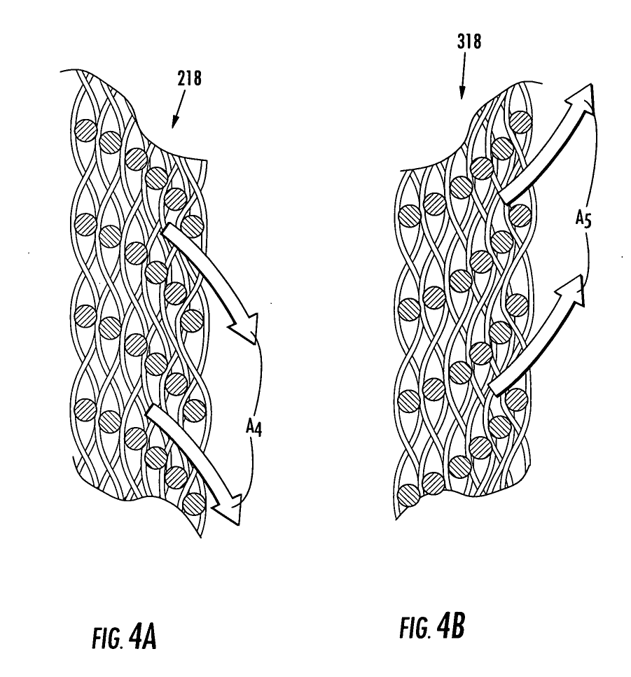

According to embodiments of the present invention, air duct outlets may be covered with a porous layer of woven fabric that has one or more weave patterns that are configured to direct an air stream in a predetermined direction. As illustrated in FIG. 4A, a woven fabric 218 has a weave pattern that is configured to direct an air stream in a generally downward direction, indicated by arrows A₄. As illustrated in FIG. 4B, a woven fabric 218 has a weave pattern that is configured to direct an air stream in a generally upward direction, indicated by arrows A₅. Embodiments of the present invention can also include weave patterns that are configured to direct an air stream in other directions including, but not limited to, generally leftward directions and generally rightward directions. Embodiments of the present invention also can achieve air flow that is greater than 45° from a direction normal to an outlet and without causing large pressure drops and lower flow rates.

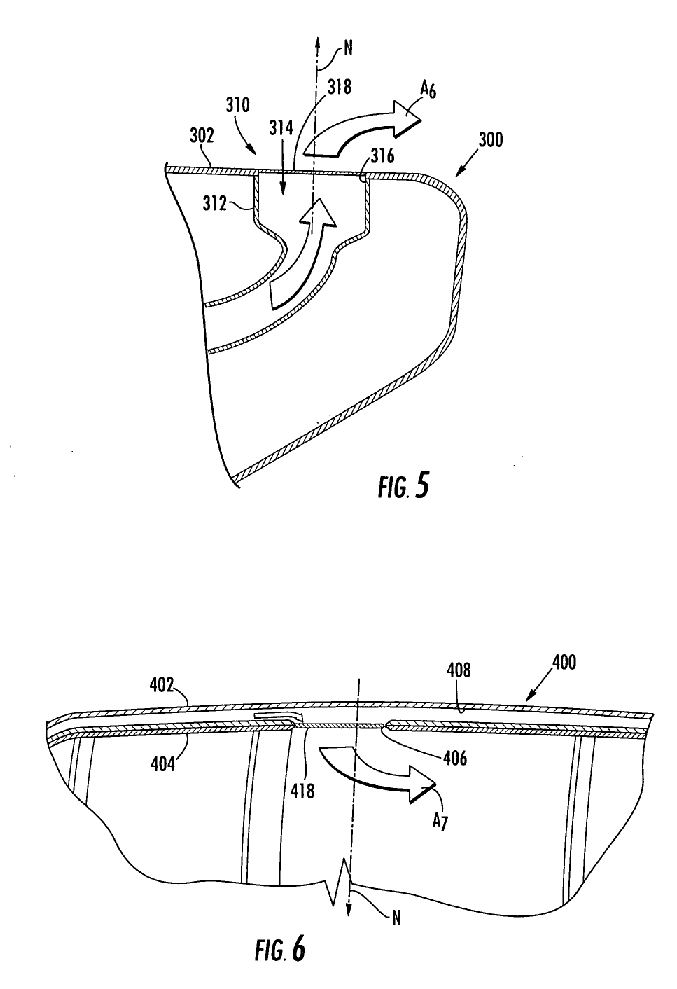

According to embodiments of the present invention, a woven fabric may be utilized to direct an air stream in a direction that is substantially transverse to a direction normal to an air passageway outlet of an air duct outlet. For example, FIG. 5 illustrates an instrument panel 300 having an air duct outlet 310 in a horizontal portion 302 of the instrument panel 300. The air duct outlet 310 includes a housing 312 that defines an air passageway 314 that terminates at outlet 316. A porous layer of woven material 318 overlies outlet 316 and has a weave pattern that is configured to direct an air stream in a direction, indicated by arrow A₆, that is substantially transverse to a direction normal, indicated by arrow N, to the outlet 316. Embodiments of the present invention can deflect airstreams in excess of 45° relative to a centerline of duct outlet without resulting in large pressure drops and/or lower air flow rates, and without requiring complex mechanisms.

FIG. 6 illustrates a vehicle 400 having a ceiling 402, a headliner 404 secured to the ceiling and having an opening 406 formed therein. A duct 408 is positioned between the ceiling 402 and headliner 404 and is in fluid communication with an air source and the opening 406 in the headliner 404 such that an air stream flowing through the duct 408 from the air source flows through the opening 406 in the headliner 404. A porous layer of woven material 418 overlies the opening 406 and has a weave pattern that is configured to direct an air stream in a direction, indicated by arrow A₇, that is substantially transverse to a direction normal, indicated by arrow N, to the opening 406. However, the porous layer of material 418 can have various weave patterns for directing air flow in any number of directions, as desired.

Embodiments of the present invention may be used within the interior compartments of any kind of vehicle including, but not limited to, automobiles, trucks, trains, boats, aircraft, and the like. Embodiments of the present invention are not limited to vehicle applications. Air duct outlets in structures such as buildings (e.g., residential homes, commercial buildings, etc.) may include a covering of porous material configured to soften and diffuse air flowing therethrough and/or to direct the airflow in one or more particular directions.

Embodiments of the present invention are advantageous because material overlying an air duct outlet can prevent insects and dust from entering an air distribution system. Air duct outlets according to embodiments of the present invention can also be quieter than conventional air duct outlets.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An air duct outlet, comprising:
a housing that defines an air passageway with an inlet and outlet; and
a porous layer of material overlying the air passageway outlet, wherein the porous layer of material softens and diffuses an air stream flowing through the air passageway outlet.

2. The air duct outlet of claim 1, wherein the porous layer of material causes an air stream flowing through the air passageway outlet to spread out in multiple directions.

3. The air duct outlet of claim 1, wherein the porous layer of material causes an air stream flowing through the air passageway outlet to generate a predetermined audible tone.

4. The air duct outlet of claim 1, wherein the porous layer of material comprises fabric.

5. The air duct outlet of claim 1, wherein the porous layer of material comprises metallic mesh.

6. The air duct outlet of claim 1, wherein the porous layer of material comprises fabric and metallic mesh.

7. The air duct outlet of claim 1, further comprising a louver assembly within the housing, wherein the louver assembly is configured to adjust the direction of air flowing through the housing, and wherein the louver assembly comprises a set of louvers pivotally secured within the housing in spaced-apart adjacent relationship, each louver in the set being pivotally secured about one of a plurality of substantially parallel axes, wherein the set of louvers are operably connected together such that pivotal movement of any one of the louvers in the set causes pivotal movement of the remaining louvers in the set.

8. The air duct outlet of claim 1, wherein the porous layer of material comprises woven material having a weave pattern configured to direct an air stream flowing through the air passageway outlet in a predetermined direction.

9. The air duct outlet of claim 8, wherein the predetermined direction is transverse to a direction normal to the air passageway outlet.

10. An air duct outlet, comprising:
a housing that defines an air passageway with an inlet and outlet; and
a porous layer of woven fabric overlying the air passageway outlet, wherein the woven fabric softens and diffuses an air stream flowing therethrough, and wherein the woven fabric comprises a weave pattern configured to direct an air stream flowing through the air passageway outlet in a predetermined direction, and wherein the predetermined direction is transverse to a direction normal to the air passageway outlet.

11. The air duct outlet of claim 10, wherein the porous layer of woven fabric causes an air stream flowing through the air passageway outlet to generate a predetermined audible tone.

12. A vehicle, comprising:
an instrument panel; and
an air duct outlet disposed within the instrument panel, wherein the air duct outlet comprises:
a housing that defines an air passageway with an inlet and outlet; and
a porous layer of material overlying the air passageway outlet, wherein the porous layer of material hides the air duct outlet from view, and wherein the porous layer of material is configured to soften and diffuse an air stream flowing through the air passageway outlet.

13. The vehicle of claim 12, wherein the porous layer of material causes an air stream flowing through the air passageway outlet to spread out in multiple directions.

14. The vehicle of claim 12, wherein the porous layer of material comprises fabric.

15. The vehicle of claim 12, wherein the porous layer of material comprises metallic mesh.

16. The vehicle of claim 12, wherein the porous layer of material comprises fabric and metallic mesh.

17. The vehicle of claim 12, further comprising a louver assembly within the housing, wherein the louver assembly is configured to adjust the direction of air flowing through the housing, and wherein the louver assembly comprises a set of louvers pivotally secured within the housing in spaced-apart adjacent relationship, each louver in the set being pivotally secured about one of a plurality of substantially parallel axes, wherein the set of louvers are operably connected together such that pivotal movement of any one of the louvers in the set causes pivotal movement of the remaining louvers in the set.

18. The vehicle of claim 12, wherein the porous layer of material comprises woven material having a weave pattern configured to direct an air stream flowing through the air passageway outlet in a predetermined direction.

19. The vehicle of claim 18, wherein the predetermined direction is transverse to a direction normal to the air passageway outlet.

20. A vehicle, comprising:
an air source;
an instrument panel comprising one or more perforated portions, wherein the one or more perforated portions are in communication with the air source such that an air stream flowing from the air source flows through the one or more perforated portions; and
a porous layer of material overlying the one or more perforated portions, wherein the porous layer of material is configured to soften and diffuse air flowing through the one or more perforated portions from the air source.

21. The vehicle of claim 20, wherein the porous layer of material hides the one or more perforated portions from view.

22. The vehicle of claim 20, wherein the porous layer of material causes an air stream flowing through the one or more perforated portions to spread out in multiple directions.

23. The vehicle of claim 20, wherein the porous layer of material causes an air stream flowing through the one or more perforated portions to generate a predetermined audible tone.

24. The vehicle of claim 20, wherein the porous layer of material comprises fabric.

25. The vehicle of claim 20, wherein the porous layer of material comprises metallic mesh.

26. The vehicle of claim 20, wherein the porous layer of material comprises fabric and metallic mesh.

27. The vehicle of claim 20, wherein the layer of material comprises woven material having a weave pattern configured to direct an air stream flowing through the air passageway outlet in a predetermined direction.

28. The vehicle of claim 27, wherein the predetermined direction is transverse to a direction normal to the air passageway outlet.

29. A vehicle, comprising:
a roof panel;
a headliner secured to an interior surface of the roof panel and comprising an opening therein;
an air source;
a duct positioned between the interior surface of the roof panel and headliner, wherein the duct is in communication with the air source and the opening in the headliner such that an air stream flowing through the duct from the air source flows through the opening in the headliner; and
a porous layer of material overlying the opening in the headliner, wherein the porous layer of material is configured to soften and diffuse air flowing through the opening in the headliner from the air source.

30. The vehicle of claim 29, wherein the porous layer of material hides the opening in the headliner from view.

31. The vehicle of claim 29, wherein the porous layer of material causes an air stream flowing through the opening in the headliner to spread out in multiple directions.

32. The vehicle of claim 29, wherein the porous layer of material comprises fabric.

33. The vehicle of claim 29, wherein the porous layer of material comprises metallic mesh.

34. The vehicle of claim 29, wherein the porous layer of material comprises fabric and metallic mesh.

35. The vehicle of claim 29, wherein the layer of material comprises woven material having a weave pattern configured to direct an air stream flowing through the opening in the headliner in a predetermined direction.

36. The vehicle of claim 35, wherein the predetermined direction is transverse to a direction normal to the opening in the headliner.

37. A structure, comprising:
a panel;
an air duct outlet disposed within the panel and comprising a housing that defines an air passageway with an inlet and outlet, wherein the air passageway inlet is in communication with an air source such that an air stream flowing from the air source flows through the air duct outlet; and
a porous layer of material overlying the air duct outlet, wherein the porous layer of material is configured to soften and diffuse air flowing through the air duct outlet.

38. The structure of claim 37, wherein the porous layer of material hides the air duct outlet from view.

39. The structure of claim 37, wherein the porous layer of material causes an air stream flowing through the air duct outlet to generate a predetermined audible tone.

40. The structure of claim 37, wherein the porous layer of material comprises fabric.

41. The structure of claim 37, wherein the porous layer of material comprises metallic mesh.

42. The structure of claim 37, wherein the porous layer of material comprises fabric and metallic mesh.

43. The structure of claim 37, wherein the porous layer of material comprises woven material having a weave pattern configured to direct an air stream flowing through the air passageway outlet in a predetermined direction.

44. The structure of claim 43, wherein the predetermined direction is transverse to a direction normal to the air passageway outlet.
